(19) United States
(12) Patent Application Publication
(10) Pub. No.: US 2006/0210465 A1
(43) Pub. Date: Sep. 21, 2006

(54) Anisotropic material treatment heater tubes

(75) Inventor: Richard Clark, Findlay, OH (US)

Correspondence Address: JOHN S. PRATT, ESQ;KILPATRICK STOCKTON, LLP, 1100 PEACHTREE STREET, ATLANTA, GA, 30309, US

(73) Assignee: The Morgan Crucible Company plc

(21) Appl. No.: 11/366,293

(22) Filed: Mar. 2, 2006

Related U.S. Application Data
(60) Provisional application No. 60/658,559, filed on Mar. 4, 2005.

(51) Int. Cl. C01B 31/06

(52) U.S. Cl. 423/446; 165/177

(57) ABSTRACT

A material treatment heater tube is provided in which the axial thermal conductivity is less than 10% of the circumferential thermal conductivity.

This application claims priority to U.S. Provisional Application Ser. No. 60/658,559 entitled “ANISOTROPIC MATERIAL TREATMENT HEATER TUBES”, filed Mar. 4, 2005, the contents of which are incorporated herein by reference.

### FIELD OF THE INVENTION

This invention relates to material treatment heater tubes and is particularly although not exclusively applicable to material treatment heater tubes for use in high pressure high temperature (HPHT) synthesis.

### DESCRIPTION OF RELATED ART

Material treatment heater tubes are tubes used to produce heat through resistance to electrical current produced in the heater tube either by electrical conduction or induction and thereby induce permanent or long-lasting changes in the chemical composition and or physical state of aggregation of material after treatment within the tube. The material may be static within the tube or passing through the tube. One application in which heater tubes are used is HPHT synthesis in which the material is static within the tube. Most well known as being made by this route is diamond, however a further material that can be made by such a route is cubic boron nitride [CBN]. The present invention is intended to cover any material made by high pressure high temperature synthesis.

HPHT diamond synthesis involves the application of high pressures and high temperatures to a source of carbon which is transformed by these conditions into diamond. One method used in such diamond synthesis is the temperature gradient method, developed by Wentorf, Jr. (U.S. Pat. No. 3,297,407) and subsequently refined by Strong (U.S. Pat. No. 4,042,673, U.S. Pat. No. 4,082,185 and U.S. Pat. No. 4,301,134) and others. This has become the most favoured technique for growing high-quality large diamonds for use in gemstone and other applications, such as substrates for semiconductors.

In this method a temperature gradient is maintained between a source of carbon and a seed, the source and seed being separated by a metallic solvent/catalyst. Carbon dissolves into the solvent/catalyst and then precipitates onto the seed as diamond. The growth of diamond on the seed is driven by the difference in solubility of diamond between that at the molten catalyst-solvent metal at the source of carbon and that at the seed, this solubility difference being caused by the temperature difference. The temperature gradient is maintained for example by varying the thickness of the heater tube wall, and/or varying the properties of insulating material between the heater tube and a reaction cell in which the diamond growth takes place.

Temperature control is critical to the success of this process in producing high quality diamonds. In order to produce growth of large diamonds without defects such as inclusions, stacking faults, dislocations and atomic impurities or with a minimum of these, the careful adjustment of pressure and temperature and use of relatively small, but highly controlled temperature gradients are required, together with extended growth times. Additional measures are required to prevent problems such as spontaneous nucleation of non-seeded diamonds, and partial or complete dissolution of the seed diamond in the molten catalyst-solvent metal. Similarly, the addition to the source/solvent system of dopants, getters and compensators functioning as modifiers of the physical, mechanical and/or electrical properties of diamonds, is also known.

The effect of failure to control temperature adequately can be seen to advantage in “Growth Temperature Effects of Impurities in HPHT Diamonds”, Kanda & Lawson, Industrial Diamond Review February 1995, pgs. 56-61). This showed that temperature changes of about 50° C. at ˜1500° C. and ˜6 GPa pressure gave extreme differences in appearance. To provide better results temperature control over a very limited range is desirable (e.g. ±10° C., preferably ±5° C.). High pressures and temperatures are also used in treating natural diamonds to overcome defects. Good temperature control is likely to provide beneficial results in such treatments also.

Typical apparatus used in such methods is shown schematically in U.S. Pat. No. 6,030,595 (and in more detail in U.S. Pat. No. 3,297,407) and comprises a heater tube that is heated by resistance to a conducted current.

EP0632479 used pyrolytic graphite ring heaters for electron emitters, of vacuum tubes. The heaters were chosen for their electrical and mechanical properties rather than their thermal conductivity properties.

Conventional heater tubes are made of graphite so as to withstand the temperatures required for diamond synthesis. A problem however is that the heaters used in such apparatus are themselves conductors of heat and so maintaining a gradient can be problematic.

In a different field, continuous growth of crystals by freezing from a melt, it has been proposed to provide a wall having a laminated structure of alternate high and low thermal conductivity to provide a low axial thermal conductivity and high transverse thermal conductivity [JP2004-083301]. This wall does not act as a heating element.

In a similar field it has also been proposed to provide a die of anisotropic material having a low axial thermal conductivity and high transverse thermal conductivity [U.S. Pat. No. 3,249,404]. This die does not act as a heating element.

### SUMMARY OF THE INVENTION

The present invention provides a heater tube in which the axial thermal conductivity is less than 10%, preferably less than 5%, more preferably less than 2% of the circumferential thermal conductivity.

By a heater tube is meant a tube that is used to generate heat by electrical conduction, induction, or otherwise.

Preferably the axial thermal conductivity is less than 15 W.m⁻¹.K⁻¹, more preferably, less than 10 W.m⁻¹.K⁻¹.

The heater tube may achieve this anisotropy either through choice of material, or through use of a laminated structure, or both.

The high thermal conductivity anisotropy will reduce heat transfer along the tube (so helping in maintaining a temperature gradient) but will permit good heat transfer from the heater tube to the material being heated. It will also ensure a relatively uniform distribution in a circumferential direction.

Further details of the invention will become apparent from the following illustrative description with reference to the drawings in which:—

### BRIEF DESCRIPTION OF THE DRAWINGS

FIG. 1 is a schematic view of a conventional heater tube;

FIG. 2 is a schematic view of a heater tube in accordance with the present invention

FIG. 3 is a schematic view of a further heater tube in accordance with the present invention

FIG. 4 is a schematic view of a still further heater tube in accordance with the present invention

FIG. 5 is a schematic view of a yet further heater tube in accordance with the present invention.

### DETAILED DESCRIPTION OF SPECIFIC EMBODIMENTS

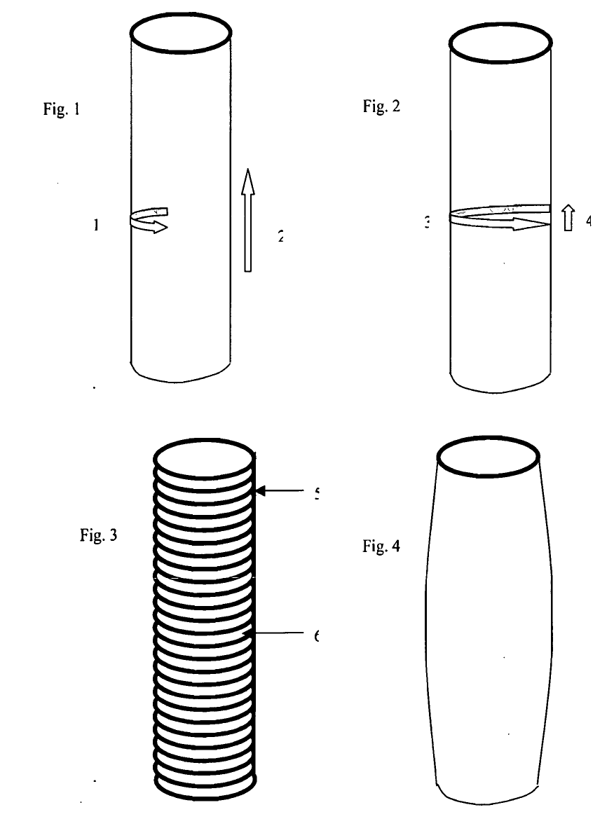

In FIG. 1 a conventional heater tube is shown in which the circumferential thermal conductivity 1 is of the same order as the axial thermal conductivity 2. Hence heat transfer around the tube is similar in scale to heat transfer along the tube.

In diamond synthesis, graphite heater tubes are used because graphite has suitable electrical properties, and is capable of withstanding the high temperatures required in diamond synthesis.

The crystal structure of graphite is a layered structure in which there is strong bonding within the layers and weak bonding between the layers. The layers of graphite can be rotationally oriented randomly with respect to each other or can be aligned, and the properties of graphite can differ significantly depending upon the degree of orientation.

The graphite heater tubes in standard use are typically a machined graphite tube, manufactured from a fine-to-medium grain graphite. This base graphite grade is either extruded or is machined from a pressed block. Extruded graphites offer a level of anisotropy with the most thermally conductive direction being in the vertical direction (with the grain). The level of anisotropy in pressed blocks, regardless of manufacturing route and grain size, is lower than this such that the graphites are generally isotropic in their properties, despite the fact that graphite itself is an anisotropic material. It will be apparent that with an extruded tube the thermal conductivity will be higher along the length of the tube than circumferentially of the tube.

Graphite can be produced in bulk as a highly anisotropic material in the form of pyrolytic graphite. Pyrolytic graphite is produced by the thermal decomposition of carbon containing gases so that it is formed layer by layer. This is an expensive process. The layers produced in pyrolytic graphite tend to be randomly oriented and this randomness can be reduced by annealing (high temperature heat treatment) which results in a greater degree of orientation. Highly oriented pyrolytic graphite (HOPG) is obtained by annealing under pressure and has higher orientation still. As the degree of orientation increases, the interlayer spacing decreases and this affects the physical properties of the graphite such as thermal conductivity. Such anisotropic materials are ideal for making heater tubes according to the invention.

In FIG. 2 a heater tube according to the present invention is shown in which the circumferential thermal conductivity 3 is much higher axial thermal conductivity 4. Hence heat transfer around the tube remains as efficient as (or better than) in a conventional heater tube while heat transfer along the tube is considerably reduced.

The heater tube of FIG. 2 may be made of an anisotropic material or the structure of the heater tube may be such as to provide that anisotropy by laminating layers of high and low thermal conductivity as is shown in FIG. 3 in which high thermal conductivity layers 5 are separated by low thermal conductivity material 6.

Table 1 shows thermal conductivities in various carbon materials and indicates the degree of anisotropy by showing the “through plane” conductivity as a percentage of the “in plane” conductivity.

TABLE 1

| | | | Through plane |
|---|---|---|---|
| | | | conductivity |
| | Thermal conductivity | | a percentage |
| | (W · m⁻¹ · K⁻¹) | | of in plane |
| Material | In plane | Through plane | conductivity |
| Bulk carbon/graphite | ˜50-100 | ˜50-100 | 100% |
| Exfoliated graphite | ˜100-500 | ˜6-10 | 1.2-10% |
| sheet | | | |
| Pyrolytic graphite | ˜300 | ˜3-4 | 1-1.3% |
| Annealed pyrolytic | ˜1700 | ˜10 | 0.6% |
| graphite | | | |
| Highly oriented | ˜2000 | ˜10 | 0.5% |
| pyrolytic graphite | | | |

It can readily be seen that pyrolytic graphite (PG) provides a high degree of anisotropy. By forming a heater tube from this material, with the correct alignment transverse to the tube axis, a heater tube will result with an axial thermal conductivity of about 3 to 8% of that of a conventional heater tube. The circumferential thermal conductivity will be about 3 to 6 times that of a conventional element and so uniform heating around the material being heated will result.

Both annealed pyrolytic graphite and highly oriented pyrolytic graphite (HOPG) provide significantly higher in plane thermal conductivity but at the cost of higher through plane thermal conductivity. Heater tubes made of such materials will give highly uniform temperature distributions about their periphery, and about 20% of the heat transfer along the heater tube—so permitting the maintenance of temperature gradients.

Pyrolytic graphite is expensive and annealed and highly oriented pyrolytic graphites more so. A heater tube formed of stacked sheets of exfoliated graphite is likely to provide a reasonable anisotropy in thermal conductivities and at a significantly lower cost than a pyrolytic graphite. Exfoliated graphite sheet can be obtained from Grafrech International Ltd. of Wilmington, Del., USA under the Grafoil® trademark.

Other forms of carbon that have high anisotropy include carbon fibre reinforced carbon composites, and extruded graphite materials such as disclosed in WO02/090291. Provided the degree of anisotropy is sufficient, and the orientation is appropriate, such materials may be used in the present invention.

While the above has concentrated on diamond synthesis applications, similar considerations apply in any application where an axial temperature gradient is required within a heater tube. For example annealing applications for wires, filaments, and tubes.

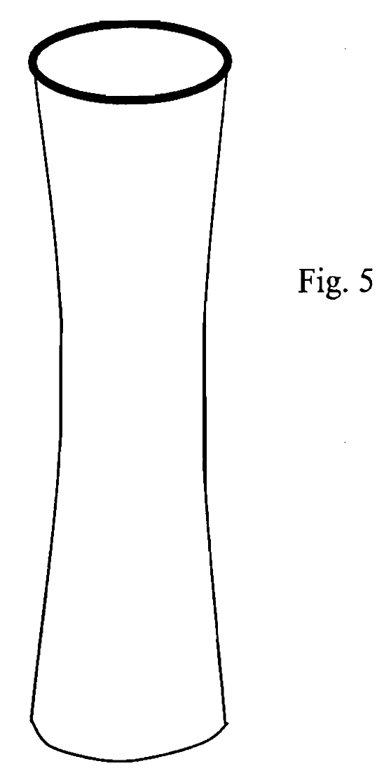

In the phrase “heater tube” the word “tube” should be taken as any extended body, surrounding a cavity. Typically a “tube” is at least as long axially as it is wide transversely of the tube axis (i.e. for a cylindrical tube the length of the tube is at least as long as the diameter of the tube), however the invention is also applicable to shorter tubes. The word “tube” in this context is not restricted to any particular cross section. The tube may have apertures or protrusions and may if required be tapered, flared, or have varying cross section as demanded by the application. For Example, FIG. 4 shows a tube of varying cross section having a barrel-like broadening in its middle to provide enhanced heating at its ends to overcome loss of heat at the ends. FIG. 5 shows a tube of varying cross section having a narrowing in its middle to provide a relatively short high temperature region with lower temperature regions either side. Although the conditions in a diamond synthesis cell are extreme, the lessons learnt can be applied in less extreme environments.

For lower temperature applications the heater tube may comprise laminations of metal with laminations of low thermal conductivity material.

1. A material treatment heater tube for high pressure high temperature synthesis, in which the axial thermal conductivity is less than 10% of the circumferential thermal conductivity.

2. The material treatment heater tube, as claimed in claim 1, in which the axial thermal conductivity is less than 5% of the circumferential thermal conductivity.

3. The material treatment heater tube, as claimed in claim 2, in which the axial thermal conductivity is less than 2% of the circumferential thermal conductivity.

4. The material treatment heater tube, of claim 1, in which the axial thermal conductivity is less than 15 W.m⁻¹.K⁻¹.

5. The material treatment heater tube, as claimed in claim 4, in which the axial thermal conductivity is less than 10 W.m⁻¹.K⁻¹.

6. The material treatment heater tube, as claimed in claim 1, in which the heater tube is formed at least in part from an anisotropic material.

7. The material treatment heater tube, as claimed in claim 6, in which the heater tube is formed at least in part from an aligned graphite.

8. The material treatment heater tube, as claimed in claim 7, in which the heater tube is formed at least in part from pyrolytic graphite.

9. The material treatment heater tube, as claimed in claim 7, in which the heater tube is formed at least in part from annealed pyrolytic graphite.

10. The material treatment heater tube, as claimed in claim 7, in which the heater tube is formed at least in part from highly oriented pyrolytic graphite.

11. The material treatment heater tube, as claimed in claim 1, in which the heater tube has a laminated structure.

12. The material treatment heater tube, as claimed in claim 11, in which the laminated structure comprises laminations of high thermal conductivity material with low thermal conductivity material.

13. The material treatment heater tube, as claimed in claim 11, in which the laminated structure comprises laminations of graphite sheet material.

14. The material treatment heater tube, as claimed in claim 1, in which the cross section of the tube varies along its length.

15. The material treatment heater tube, as claimed in claim 14, in which the wall thickness of the tube varies along its length.

16. The material treatment heater tube, as claimed in claim 1, in which the heater tube is a material treatment heater tube for a diamond synthesis apparatus.

17. A heating apparatus comprising a material treatment heater tube as claimed in claim 1.

18. canceled

19. canceled

20. An apparatus for the synthesis of diamond, comprising the material treatment heating tube of claim 1.

21. A temperature-gradient method for diamond synthesis, comprising:
heating a mixture of a source of carbon, a seed, and a metallic solvent/catalyst by a material treatment heating tube of claim 1, thereby maintaining and controlling a temperature gradient between the source of carbon and the seed.
